(19) United States
(12) Patent Application Publication
(10) Pub. No.: US 2026/0140793 A1
(43) Pub. Date: May 21, 2026

(54) NOTIFICATION PROCESSING METHOD, TERMINAL DEVICE, SERVER AND COMPUTER STORAGE MEDIUM

(71) Applicant: CLOUD INTELLIGENCE ASSETS HOLDING (SINGAPORE) PRIVATE LIMITED, Singapore (SG)

(72) Inventors: Xiaolu TONG, Shanghai (CN); Qinghe XU, Shanghai (CN); Yun PIAO, Hangzhou, Zhejiang (CN); Jia RONG, Hangzhou, Zhejiang (CN); Xiaolu CHU, Hangzhou, Zhejiang (CN); Ke ZHANG, Hangzhou, Zhejiang (CN)

(21) Appl. No.: 19/114,631

(22) PCT Filed: Sep. 21, 2023
(86) PCT No.: PCT/CN2023/120295

§ 371 Date: Mar. 24, 2025

(30) Foreign Application Priority Data
Sep. 23, 2022 (CN) 202211170315.1

(51) Int. Cl. G06F 9/54; G06F 3/04842

(52) U.S. Cl. CPC G06F 9/542; G06F 3/04842

(57) ABSTRACT

Embodiments of the present application provide a notification processing method, a terminal device, a server, and a computer storage medium. The notification processing method includes: obtaining, through a cloud desktop, a notification message of a second operating system independent of an operating system of the cloud desktop; displaying the notification message of the second operating system in a first notification area of the cloud desktop; receiving a trigger operation for the notification message in the first notification area, redirecting the trigger operation to a notification message corresponding to the second operating system, so as to process the notification message in the second operating system according to the trigger operation. Through the solution provided by this embodiment, the user can learn about the notification information of the second operating system through the cloud desktop and process the notification message, achieving the interactive effect with cloud integration and improving the user experience.

### CROSS-REFERENCE TO RELATED APPLICATIONS

This application is a National Stage of International Application No. PCT/CN2023/120295, filed on Sep. 21, 2023, which claims priority to Chinese Patent Application No. 202211170315.1, entitled “NOTIFICATION PROCESSING METHOD, TERMINAL DEVICE, SERVER AND COMPUTER STORAGE MEDIUM” and filed with the China National Intellectual Property Administration on Sep. 23, 2022. The afore-mentioned applications are hereby incorporated by reference in their entireties.

### TECHNICAL FIELD

Embodiments of this application relate to the field of computer technology and, in particular, to a notification processing method, a terminal device, a server and a computer storage medium.

### BACKGROUND

Cloud computer is an integrated service solution, including cloud resources, transmission protocols and cloud terminals. The open cloud terminal of the cloud computer may provide desktop, application, hardware and other resources to users through the transmission protocol in an on-demand service and elastic allocation service mode. Thus a single computer for multi-user can be easily realized.

The cloud computer adopts the way of Desktop as a Service (DaaS). The cloud may provide a user with a virtual desktop, and all the user's applications are running in the virtual desktop. The picture of the virtual desktop may be transmitted to a terminal device operated by the user.

However, in the process of the immersive operation of a cloud computer, the operated cloud computer is isolated from other operating systems, for example, a local operating system of the terminal, or other cloud computers, resulting in the inability to conveniently obtain notification information of other operating systems in the process of the immersive operation of the cloud computer, affecting the user experience.

### SUMMARY

In view of this, embodiments of the present application provide a notification processing solution to at least partially solve the above problem.

According to a first aspect of the embodiments of the present application, a notification processing method is provided, including: obtaining, through a cloud desktop, a notification message of a second operating system independent of an operating system of the cloud desktop; displaying the notification message of the second operating system in a first notification area of the cloud desktop; receiving a trigger operation for the notification message in the first notification area, redirecting the trigger operation to a notification message corresponding to the second operating system, so as to process the notification message in the second operating system according to the trigger operation.

According to a second aspect of the embodiments of the present application, a notification processing method is provided, including: obtaining a notification message of a cloud desktop through a second operating system, where the cloud desktop is set in a background of the second operating system; displaying the notification message of the cloud desktop in a second notification area of the second operating system; receiving a trigger operation for the notification message in the second notification area, redirecting the trigger operation to the cloud desktop, so as to process the notification message in the cloud desktop according to the trigger operation.

According to a third aspect of the embodiments of the present application, a notification processing method is provided, which is applied to a server of a cloud desktop and includes: receiving a notification message transmitted based on a cloud desktop protocol, where the notification message is a notification message of a second operating system independent of an operating system of the cloud desktop; sending a desktop data stream to a terminal device, where the desktop data stream is used to display the cloud desktop, and the notification message of the second operating system is displayed in a first notification area of the displayed cloud desktop, where the desktop data stream is generated by the server based on a notification message of the cloud desktop and a notification message of the terminal device; obtaining a trigger operation transmitted by the terminal device based on the cloud desktop protocol, redirecting the trigger operation to the notification message of the second operating system, and transmitting the redirected trigger operation to the second operating system, so as to process the notification message in the second operating system according to the trigger operation, where the trigger operation is a trigger operation for the notification message in the first notification area.

According to a fourth aspect of the embodiments of the present application, a notification processing method is provided, which is applied to a server of a cloud desktop and includes: transmitting a notification message of the cloud desktop to a second operating system, so as to display the notification message of the cloud desktop in a second notification area of the second operating system, where the cloud desktop is set in a background of the second operating system, and the second notification area is used to receive a trigger operation for the notification message; obtaining, from the second operating system, the trigger operation for the notification message, where the trigger operation for the notification message has been redirected to the cloud desktop, and processing the notification message according to the trigger operation.

According to a fifth aspect of the embodiments of the present application, a terminal device is provided, including: a processor, a memory, a communication interface and a communication bus, where the processor, the memory and the communication interface communicate with each other through the communication bus; the memory is configured to store at least one executable instruction, and the executable instruction causes the processor to perform an operation corresponding to the method described in the first aspect or the second aspect.

According to a sixth aspect of the embodiments of the present application, a server is provided, including a memory, a processor and a computer program stored on the memory, and when the processor executes the computer program, the method described in any of the third or fourth aspects is implemented.

According to a seventh aspect of the embodiments of the present application, a computer storage medium is provided, on which a computer program is stored, and when the program is executed by a processor, the method described in any of the above aspects is implemented.

According to the notification processing scheme provided in the embodiments of the present application, the notification message of the second operating system can be integrated into the cloud desktop, so that the user can timely learn about the notification information of the second operating system even in the process of immersive operation of the cloud desktop, and the notification message of the second operating system can be processed through the cloud desktop, thereby improving the user experience.

### BRIEF DESCRIPTION OF DRAWINGS

In order to more clearly illustrate the technical solutions in the embodiments of the present application or the prior art, the drawings required for the description of the embodiments or the prior art will be briefly introduced below. Obviously, the drawings described below are only intended for some embodiments recorded in the embodiments of the present application. For those of ordinary skill in the art, other drawings can also be obtained based on these drawings.

FIG. 1 is a schematic diagram of an exemplary system to which a notification processing method according to an embodiment of the present application is applicable.

FIG. 2A is a flowchart of steps of a notification processing method according to an embodiment of the present application.

FIG. 2B is a schematic diagram of a scenario example for the embodiment shown in FIG. 2A.

FIG. 3 is a flowchart of steps of another notification processing method according to an embodiment of the present application.

FIG. 4 is a flowchart of steps of another notification processing method according to an embodiment of the present application.

FIG. 5 is a flowchart of steps of a notification processing method applied to a server according to an embodiment of the present application.

FIG. 6 is a flowchart of steps of another notification processing method applied to a server according to an embodiment of the present application.

FIG. 7 is an interactive flowchart according to an embodiment of the present application.

FIG. 8 is another interactive flowchart according to an embodiment of the present application.

FIG. 9 is a schematic structural diagram of a terminal device according to an embodiment of the present application.

### DESCRIPTION OF EMBODIMENTS

In order to make people in the art to better understand the technical solutions in the embodiments of the present application, the technical solutions in the embodiments of the present application will be clearly and comprehensively described in combination with the drawings for the embodiments of the present application. Obviously, the described embodiments are only part of embodiments of the present application, not all of them. All other embodiments obtained by those of ordinary skill in the art based on the embodiments in the embodiments of the present application should belong to the protection scope of the embodiments of the present application.

The specific implementations of the embodiments of the present application are further described below in conjunction with the accompanying drawings for the embodiments of the present application.

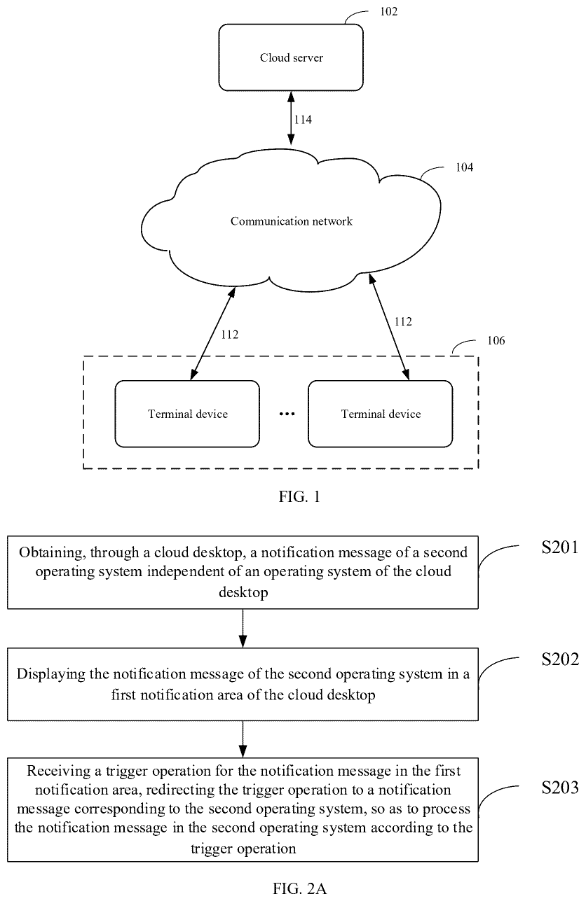

FIG. 1 shows an exemplary system to which a notification processing method according to an embodiment of the present application is applicable. As shown in FIG. 1, the system 100 may include a cloud server 102, a communication network 104 and/or one or more terminal devices 106, and there are multiple terminal devices in the example of FIG. 1.

The cloud server 102 may be any suitable device for storing information, data, programs and/or any other suitable type of content, including but not limited to a distributed storage system device, a server cluster, a computing cloud server cluster. In some embodiments, the cloud server 102 may perform any suitable function. For example, in some embodiments, the cloud server 102 may provide one or more cloud desktops. As an example, in some embodiments, the cloud server 102 may be used to run a cloud application. As another example, in some embodiments, the cloud server 102 may be used to send a desktop data stream for displaying a cloud desktop to a terminal device.

In some embodiments, the communication network 104 may be any suitable combination of one or more wired and/or wireless networks. For example, the communication network 104 can include any one or more of the following: an Internet, an intranet, a wide area network (WAN), a local area network (LAN), a wireless network, a digital subscriber line (DSL) network, a frame relay network, an asynchronous transfer mode (ATM) network, a virtual private network (VPN), and/or any other suitable communication network. The terminal device 106 can be connected to the communication network 104 via one or more communication links (e.g., communication link 112), and the communication network 104 can be linked to the cloud server 102 via one or more communication links (e.g., communication link 114). The communication link can be any communication link suitable for transmitting data between the terminal device 106 and the cloud server 102, such as a network link, a dial-up link, a wireless link, a hard-wired link, any other suitable communication link, or any suitable combination of such links.

The terminal device 106 may include any one or more terminal devices suitable for running a program or presenting an image. In some embodiments, the terminal device 106 may include any suitable type of device. For example, in some embodiments, the terminal device 106 may include a mobile device, a tablet computer, a laptop computer, a desktop computer, a wearable computer, a cloud computer terminal, a game console, a media player, a vehicle entertainment system and/or any other suitable type of terminal device.

Based on the above system, an embodiment of the present application provides a notification processing method applied to a cloud desktop.

Cloud desktop, also known as desktop virtualization or cloud computer, is a new model to replace traditional computers. The processor, memory, hard disk and other components for the cloud desktop will be virtualized in the back-end server, so that the computer's computing and storage processes are migrated to the server, and the server can virtualize several cloud computers.

A terminal device of a user may be, for example, a mobile phone, a computer, a thin client (such as a set-top box), etc., and a cloud desktop application may be installed in the terminal device. In the running process of the cloud desktop application, a network connection may be established with the server via the network, and data communication with the server may be performed based on the cloud desktop protocol to perform cloud desktop-related interactions.

Specifically, the user may operate an interface of the cloud computer through the terminal device, and the terminal device may transmit the user's operation to the server based on the cloud desktop protocol. The server may perform calculation or storage etc. in response to the user's operation, and update the cloud desktop, and then send a desktop data stream to the terminal device so that the terminal device updates the displayed cloud desktop.

Generally, after the cloud desktop application is opened in the terminal device, the cloud desktop may be displayed in full screen on the terminal device so that the user can operate the cloud desktop in an immersive way. At this time, other applications of the terminal device are set in the background, and the operating system of the terminal device is also isolated from the cloud desktop. If other cloud computers are also running in the terminal device, the other cloud computers are also isolated from the turned-on cloud computer. The isolation of the cloud computer from other operating systems results in the user being unable to easily learn about notification information of other operating systems in the process of the immersive operation of the cloud computer, affecting the user experience.

In order to solve or alleviate the above problems, embodiments of the present application provides a notification processing method applied to a cloud desktop, which is described below through multiple embodiments.

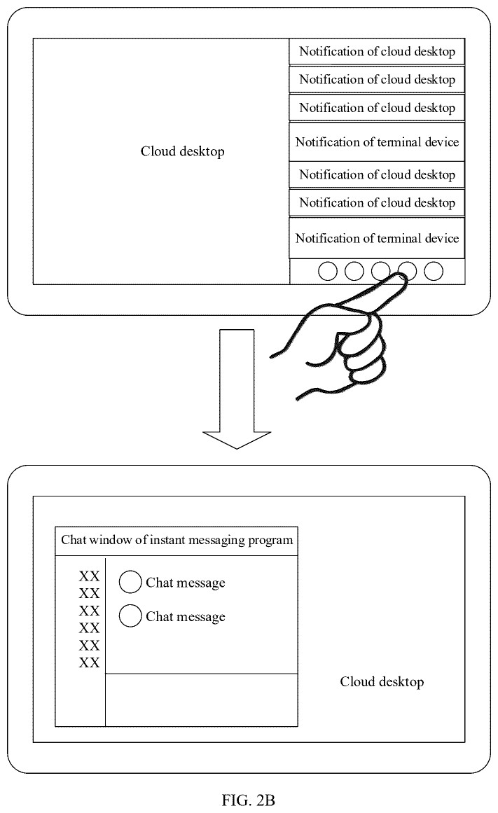

Reference is made to FIG. 2A, which illustrates a schematic flowchart of a notification processing method. As shown in the figure, the method includes the following steps.

S201, obtaining, through a cloud desktop, a notification message of a second operating system independent of an operating system of the cloud desktop.

The second operating system is independent of the operating system of the cloud desktop. Specifically, an operating environment of the second operating system may be independent of an operating environment of the operating system of the cloud desktop. For example, the operating system of the cloud desktop may run on part of devices on a server, and the second operating system may run on the terminal device or on another part of the devices on the server except the part on which the operating system of the cloud desktop runs.

For example, the operating system of the cloud desktop runs on the server, and the second operating system independent of the operating system of the cloud desktop may be an operating system running on the terminal device, or an operating system running on another cloud desktop except the cloud desktop, or an operating system for running cloud applications, as long as the second operating system is independent of the operating system of the cloud desktop. The number of the second operating system may be one or more, and this embodiment does not limit this.

The notification message of the second operating system may be a message that needs to be displayed through a notification bar of the second operating system, for example, a notification message corresponding to an instant messaging software in the second operating system, a notification message of an application such as a browser in the second operating system, a regular message or an update message of the second operating system, etc.

Through the cloud desktop, an interface of the second operating system may be called to obtain the notification message, and the notification message may be transmitted to the cloud desktop based on a cloud desktop protocol. For the specific interface called, reference may be made to the relevant art and details will not be repeated here.

S202, displaying the notification message of the second operating system in a first notification area of the cloud desktop.

In this embodiment, the first notification area of the cloud desktop may be an area preset by the operating system of the cloud desktop for displaying notifications. The first notification area may be located at any position of the cloud desktop, such as a lower right corner of the cloud desktop, an upper part of the cloud desktop, and this embodiment does not limit this.

The first notification area may be used to display the notification message of the second operating system, but is not limited to this. The first notification area may also be used to display notification information of the cloud desktop itself.

S203, receiving a trigger operation for the notification message in the first notification area, redirecting the trigger operation to a notification message corresponding to the second operating system, so as to process the notification message in the second operating system according to the trigger operation.

For receiving the trigger operation for the notification message in the first notification area, this trigger operation may specifically be a mouse click operation, a finger trigger operation, etc., and this embodiment does not limit this.

For redirecting the trigger operation to the notification message corresponding to the second operating system, a specific case may be that: obtaining location information corresponding to the notification message displayed in the first notification area of the cloud desktop, and associating the location information with the notification message in the second operating system, so as to redirect the trigger operation for the notification information in the cloud desktop to the second operating system. In other implementations of the present application, it is also possible to associate the location information of the notification message in the cloud desktop with the location information of the notification message in the second operating system, etc., and this embodiment does not limit this.

By redirecting the trigger operation to the notification message corresponding to the second operating system, the trigger operation can be synchronized to the second operating system, so that the trigger operation for the notification message is received through the cloud desktop, and the second operating system responds to the received trigger operation and performs corresponding processing. The user can learn about the notification information of the second operating system through the cloud desktop and process the notification message, achieving the interactive effect with cloud integration and improving the user experience.

The following exemplifies the solution provided in the embodiment with a specific scenario.

Reference is made to FIG. 2B. In this embodiment, the terminal device may display the cloud desktop in full screen, and the user may perform immersive operation.

The cloud desktop includes a first notification area, and the first notification area may include a number of notification messages, including some notification messages of the cloud desktop and notification messages of the terminal device.

After a notification message (for example, an icon flashing notification message of an instant messaging program) obtained from the terminal device in the cloud desktop is triggered, the triggering operation may be relocated to the operating system of the terminal device, and the operating system of the terminal device may wake up, in response to the triggering operation, a chat window of the instant messaging program to be displayed at the top layer.

In the solution provided in this embodiment, by obtaining, through the cloud desktop, the notification message of the second operating system independent of the operating system of the cloud desktop and displaying the notification message of the second operating system in the first notification area of the cloud desktop, the user can timely learn about the notification information of the second operating system even in the process of immersive operation of the cloud desktop, and can perform relevant trigger operation on the notification information by operating the cloud desktop. If a trigger operation for the notification message in the first notification area is received, the trigger operation is redirected to the notification message corresponding to the second operating system, so that the notification message is processed in the second operating system according to the trigger operation. Therefore, the notification message of the second operating system can be integrated into the cloud desktop, and the user can process the notification message through the cloud desktop. When the second operating system is the operating system of the terminal device, the solution provided in this embodiment achieves the interactive effect with cloud integration and improves the user experience.

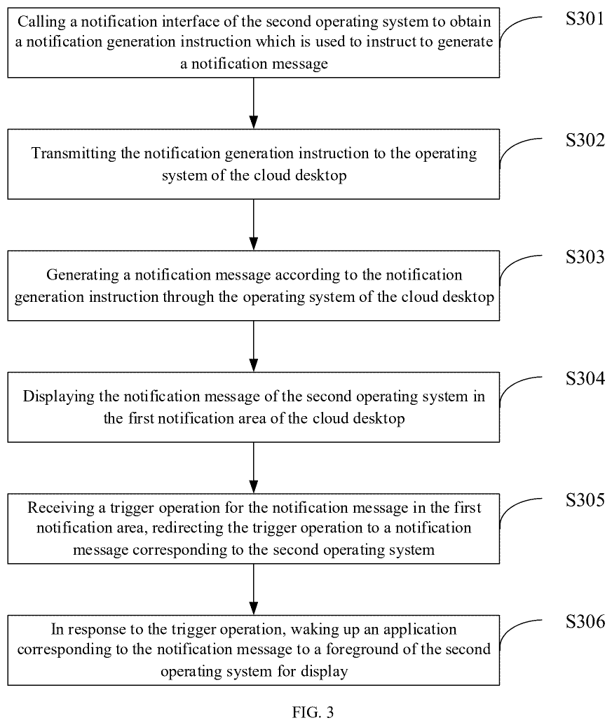

Reference is made to FIG. 3, which illustrates a schematic flowchart of another notification processing method. As shown in the figure, the method includes the following steps.

S301, calling a notification interface of the second operating system to obtain a notification generation instruction which is used to instruct to generate a notification message.

In this embodiment, multiple applications capable of notification may be running in the second operating system, and each application may generate a notification generation instruction. The second operating system may generate a notification message corresponding to the notification generation instruction according to a built-in notification rule, such as a notification filtering rule, a notification display mode.

In this embodiment, the notification interface of the second operating system is called to obtain the notification generation instruction. For example, a notification process may be running in the second operating system to receive a notification generation instruction of each application and generate a corresponding notification message. The generated notification message may include: a text notification message, a voice notification message, an icon flashing notification message, etc. Then, the notification generation instruction which is used to instruct to generate the notification message may be obtained by calling the interface of the notification process.

Of course, the above is only an example. In other implementations of the present application, the notification generation instruction for generating the notification message may also be obtained by other approaches, such as calling other interfaces, which is also within the protection scope of the present application.

S302, transmitting the notification generation instruction to the operating system of the cloud desktop.

For the specific approach of transmitting to the operating system of the cloud desktop, reference may be made to the relevant art and details will not be repeated here.

S303, generating a notification message according to the notification generation instruction through the operating system of the cloud desktop.

S304, displaying the notification message of the second operating system in the first notification area of the cloud desktop.

In this embodiment, the notification message may be generated in response to the notification generation instruction through the notification process or other program for generating notification messages in the operating system of the cloud desktop. For the specific approach of generating the notification message, reference may be made to the relevant art of the cloud desktop and details will not be repeated here.

In this embodiment, the notification message is generated according to the notification generation instruction through the operating system of the cloud desktop, so that the generated notification message can match a generation rule of the notification message in the cloud desktop, increasing the degree of integration between the notification message of the second operating system and the cloud desktop, avoiding the notification message of the second operating system that the user learns about in the process of immersive operation of the cloud desktop from being relatively abrupt, and improving the user experience.

In this embodiment, step S303 may include: filtering the notification generation instruction based on a notification filtering rule of the operating system of the cloud desktop; generating a notification message according to the filtered notification generation instruction based on a notification display rule of the operating system of the cloud desktop.

In this embodiment, the notification generation instruction obtained from the second operating system is filtered through the notification filtering rule of the cloud desktop, and the notification message is generated according to the notification display rule of the cloud desktop. The notification message of the second operating system can be displayed according to the filtering and display rules of the cloud desktop, so that the user can set through the cloud desktop a set of display rules for the process of the immersive operation of the cloud desktop. The cloud desktop is generally used for the scenarios where the user needs to focus on operations, such as office work or drawing, and the user sets through the cloud desktop a set of display rules for the process of the immersive operation of the cloud desktop, which is conducive for the user to operate the cloud desktop in an immersive way while not missing the notification information of the second operating system that is focused on, and the user does not need to check the messages of the second operating system regularly, thereby improving the user experience.

In another implementation of the present application, steps S301-S303 may be replaced by: calling a notification display interface of the second operating system to obtain notification display information corresponding to the notification message, and correspondingly step S304 may be: displaying the notification message in the first notification area of the cloud desktop according to the notification display information.

According to the above description, in this embodiment, the second operating system may generate a notification message in response to the notification generation instruction through a notification process or other program for generating notification messages, and the specific generated information can be notification display information. A display module of the second operating system may output according to the notification display message, thereby outputting the notification message to the user.

In this embodiment, the notification display interface of the second operating system may be called to obtain the notification display information generated by the second operating system in response to the notification generation instruction, and the notification message is displayed in the first notification area through the cloud desktop according to the notification display information, thereby saving the resources of the cloud computer.

For the specific solution for displaying, reference may be made to the relevant art, and details will not be repeated here.

S305, receiving a trigger operation for the notification message in the first notification area, redirecting the trigger operation to a notification message corresponding to the second operating system.

For the specific implementation of this step, reference may be made to the above step S203, and details will not be repeated here.

In this embodiment, after receiving the redirected trigger operation, the second operating system may perform the following step.

S306, in response to the trigger operation, waking up an application corresponding to the notification message to a foreground of the second operating system for display.

For example, if the notification message is a notification message of an instant messaging program, a chat window corresponding to the instant messaging program in the second operating system may be woken up to the foreground for display; if the notification message is a notification of a browser, etc., a browser result page corresponding to the notification message may be woken up to the foreground; if the notification message is a system notification, a setting interface of the operating system may be woken up to the foreground.

It should also be noted that the second operating system includes at least one of the following: an operating system of a terminal device for displaying the cloud desktop, an operating system of another cloud desktop independent of the cloud desktop, or an operating system of a cloud application independent of the cloud desktop. The following describes the use scenarios of different second operating systems.

When the second operating system is the operating system of the terminal device on which the cloud desktop runs:
the cloud desktop may be displayed in full screen through the terminal device, and notification messages of the cloud desktop itself and notification messages of the terminal device may be displayed through the first notification area of the cloud desktop. When a trigger operation for a notification message of the terminal device is received through the cloud desktop, a window of the application corresponding to the notification message may be woken up to the foreground through the terminal device to display in an overlaying manner on the cloud desktop.

When the second operating system is the operating system of another cloud desktop independent of the cloud desktop:
the first cloud desktop may be displayed in full screen through the terminal device, and notification messages of the first cloud desktop itself and notification messages of the second cloud desktop independent of the first cloud desktop may be displayed through the first notification area of the first cloud desktop. When a trigger operation for a notification message of the second cloud desktop is received through the first cloud desktop, the second cloud desktop may be woken up through the terminal device to the foreground of the terminal device for display, and a window of the application corresponding to the notification message may be displayed in the second cloud desktop.

When the second operating system is the operating system of the cloud application independent of the cloud desktop:
the cloud desktop may be displayed in full screen through the terminal device, and notification messages of the cloud desktop itself and notification messages of the cloud application may be displayed through the first notification area of the cloud desktop. When a trigger operation for a notification message of the cloud application is received through the cloud desktop, a window of the cloud application may be woken up to the foreground.

In the solution provided in this embodiment, the notification message of the second operating system can be integrated into the cloud desktop, and the notification information of the second operating system can be set to be displayed in a targeted manner by setting the notification filtering rule of the cloud desktop, thereby ensuring the user's concentration when the user operates the cloud desktop in an immersive way, and enabling the user to process the notification message through the cloud desktop. When the second operating system is the operating system of the terminal device, the solution provided in this embodiment achieves the interactive effect with cloud integration and improves the user experience.

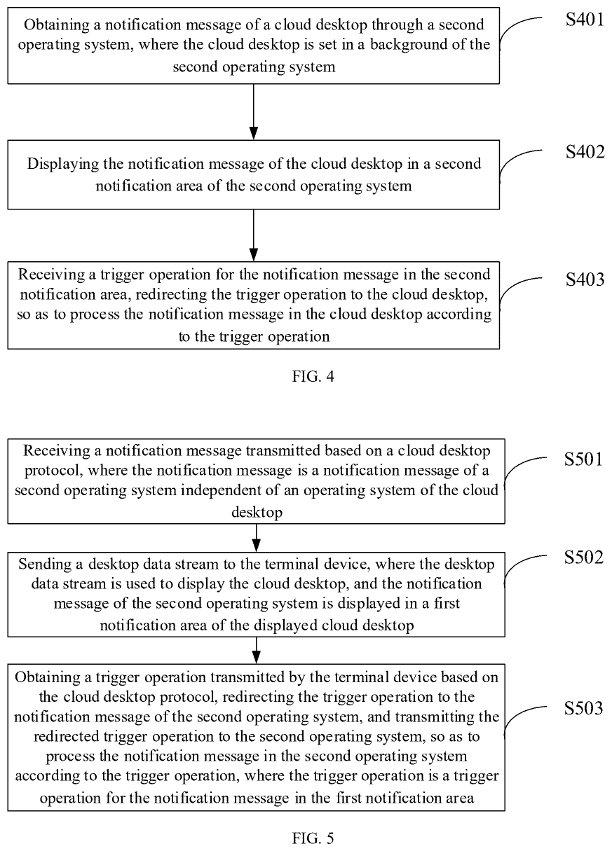

Reference is made to FIG. 4, which illustrates a schematic flowchart of another notification processing method. As shown in the figure, the method includes the following steps.

S401, obtaining a notification message of a cloud desktop through a second operating system, where the cloud desktop is set in a background of the second operating system.

S402, displaying the notification message of the cloud desktop in a second notification area of the second operating system.

S403, receiving a trigger operation for the notification message in the second notification area, redirecting the trigger operation to the cloud desktop, so as to process the notification message in the cloud desktop according to the trigger operation.

For the specific implementation of the cloud desktop, the notification message, the second operating system, redirection, etc. in this embodiment, reference may be made to the above embodiments, and details will not be repeated here.

In this embodiment, processing the notification message in the cloud desktop according to the trigger operation includes: in response to the trigger operation, waking up the cloud desktop to a foreground of the second operating system for display, and displaying a cloud application corresponding to the triggered notification message in the cloud desktop.

In this embodiment, a cloud application may be running in the cloud desktop. When the notification message of the cloud desktop is triggered, the cloud desktop may be woken up, and an application window of the cloud application corresponding to the triggered notification message may be displayed in the cloud desktop. The cloud application may be any cloud application that can run on the cloud desktop such as a drawing application, a video editing application, an instant messaging application, which is not limited in this embodiment.

In the solution provided in this embodiment, the user can timely learn about the notification information of the cloud desktop even if the user does not operate the cloud desktop, and can perform related trigger operations on the notification information by operating on the second notification area of the second operating system. Through the solution provided in this embodiment, the notification message of the cloud desktop can be integrated into the second operating system, and the user can process the notification message of the cloud desktop through the second operating system. When the second operating system is the operating system of the terminal device, the solution provided in this embodiment achieves the interactive effect with cloud integration and improves the user experience.

Reference is made to FIG. 5, which illustrates a schematic flowchart of a notification processing method that is applied to a server of a cloud desktop. The cloud desktop is generally implemented by the server and a cloud desktop application on the terminal device. The server is used to send a desktop data stream to the terminal device. The cloud desktop application is used to display the cloud desktop according to the desktop data stream, receive the user's operation on the cloud desktop, and transmit it to the server based on a cloud desktop protocol.

As shown in FIG. 5, the notification processing method includes the following steps.

S501, receiving a notification message transmitted based on a cloud desktop protocol, where the notification message is a notification message of a second operating system independent of an operating system of the cloud desktop.

When the second operating system is an operating system of the terminal device, the notification message may be obtained by the cloud desktop application calling an interface of the operating system of the terminal device. Specifically, the cloud desktop application running on the terminal device may call a data transmission interface of the terminal device and send the notification message to the server based on the cloud desktop protocol.

When the second operating system is an operating system of another cloud desktop independent of the cloud desktop, the notification message may be obtained through the cloud desktop by calling an interface of the operating system of another cloud desktop.

The server may update the cloud desktop to be displayed according to the received notification message and execute step S502.

S502, sending a desktop data stream to the terminal device, where the desktop data stream is used to display the cloud desktop, and the notification message of the second operating system is displayed in a first notification area of the displayed cloud desktop.

In this embodiment, the desktop data stream is generated by the server based on a notification message of the cloud desktop and a notification message of the terminal device, so that the cloud desktop displays its own notification message and the notification message of the second operating system.

S503, obtaining a trigger operation transmitted by the terminal device based on the cloud desktop protocol, redirecting the trigger operation to the notification message of the second operating system, and transmitting the redirected trigger operation to the second operating system, so as to process the notification message in the second operating system according to the trigger operation, where the trigger operation is a trigger operation for the notification message in the first notification area.

In the solution provided in this embodiment, the user can timely learn about the notification information of the second operating system even in the process of immersive operation of the cloud desktop, and can integrate the notification message of the second operating system into the cloud desktop. The user can process the notification message through the cloud desktop. When the second operating system is the operating system of the terminal device, the solution provided in this embodiment achieves the interactive effect with cloud integration and improves the user experience.

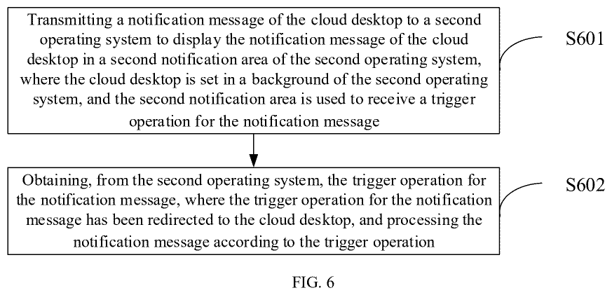

Reference is made to FIG. 6, which illustrates a schematic flowchart of a notification processing method that is applied to a server of a cloud desktop. The cloud desktop is generally implemented by the server and a cloud desktop application on the terminal device. The server is used to send a desktop data stream to the terminal device. The cloud desktop application is used to display the cloud desktop according to the desktop data stream, receive the user's operation on the cloud desktop, and transmit it to the server based on a cloud desktop protocol.

As shown in FIG. 6, the notification processing method includes the following steps.

S601, transmitting a notification message of the cloud desktop to a second operating system to display the notification message of the cloud desktop in a second notification area of the second operating system, where the cloud desktop is set in a background of the second operating system, and the second notification area is used to receive a trigger operation for the notification message.

S602, obtaining, from the second operating system, the trigger operation for the notification message, where the trigger operation for the notification message has been redirected to the cloud desktop, and processing the notification message according to the trigger operation.

In the solution provided in this embodiment, the user can timely learn about the notification information of the cloud desktop through the second operating system even if the user does not operate the cloud desktop, and can integrate the notification message of the cloud desktop into the second operating system. The user can process the notification message of the cloud desktop through the second operating system, achieving the interactive effect with cloud integration and improving the user experience.

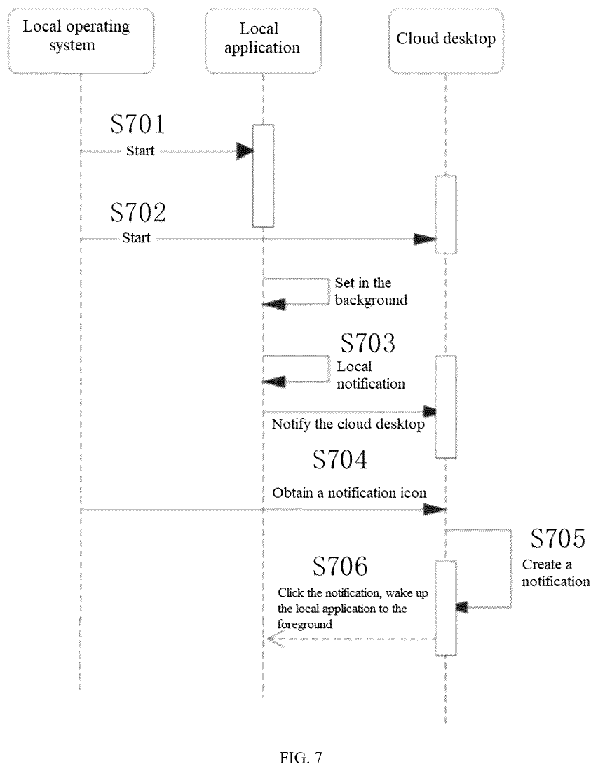

FIG. 7 exemplifies an interactive flowchart with the integration of the notification message of the terminal device into the cloud desktop taken as an example. As shown in FIG. 7, the interactive process includes the following steps.

S701, start a local application through a local operating system of a terminal device.

S702, start a cloud desktop through the terminal device and display the cloud desktop in full screen, with the local application being running in a background.

S703, the local application generates a notification message.

S704, the notification message is transmitted to the cloud desktop, and the cloud desktop obtains a notification icon from the operating system of the terminal device.

S705, the cloud desktop creates, according to the notification icon and the notification message, a corresponding notification message and displays it in a first notification area.

S706, the cloud desktop receives a trigger operation of a user clicking the notification message, and redirects the trigger operation to the local application to wake up the local application to a foreground of the terminal device.

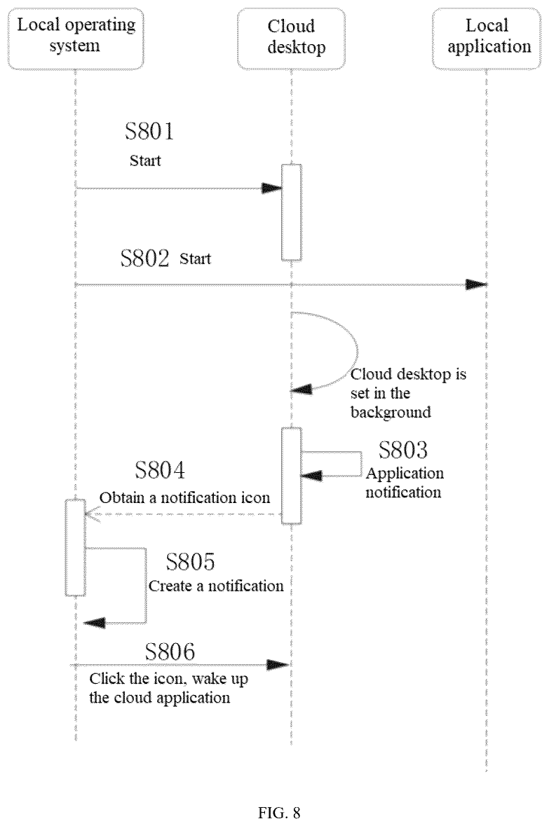

FIG. 8 exemplifies an interactive flowchart with the integration of the notification message of the cloud desktop into the terminal device taken as an example. As shown in FIG. 8, the interactive process includes the following steps.

S801, start a cloud application in a cloud desktop through a local operating system of a terminal device.

S802, start a local application through the terminal device, with the cloud desktop being running in a background.

S803, the cloud application in the cloud desktop generates a notification message.

S804, the notification message is transmitted to the local operating system of the terminal device, and the terminal device obtains a notification icon from the cloud desktop.

S805, the local operating system of the terminal device creates, according to the notification icon and the notification message, a corresponding notification message of the cloud desktop and displays it in a second notification area.

S806, the terminal device receives a trigger operation of a user clicking the notification message, redirects the trigger operation to the cloud application in the cloud desktop, wakes up the cloud desktop and displays the cloud application in a foreground of the cloud desktop.

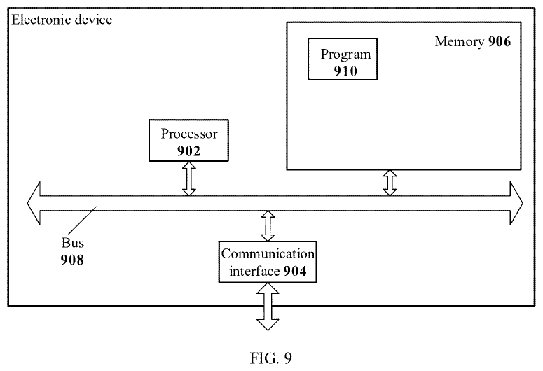

Reference is made to FIG. 9, which illustrates a schematic structural diagram of a terminal device according to an embodiment of the present application, and the specific embodiment of the present application does not limit the specific implementation of the terminal device.

As shown in FIG. 9, the terminal device may include: a processor 902, a communication interface 904, a memory 906, and a communication bus 908.

The processor 902, the communication interface 904, and the memory 906 communicate with each other through the communication bus 908.

The communication interface 904 is configured to communicate with other terminal

The processor 902 is configured to execute the program 910, and specifically, the relevant steps in the above notification processing method embodiment may be executed.

Specifically, the program 910 may include a program code, and the program code includes a computer operation instruction.

The processor 902 may be a central processing unit (CPU), or an application specific integrated circuit (ASIC), or one or more integrated circuits configured to implement the embodiments of the present application. The one or more processors included in an intelligent device may be processors of a same type, such as one or more CPUs; or may be processors of different types, such as one or more CPUs and one or more ASICs.

The memory 906 is used to store the program 910. The memory 906 may include a high-speed random access memory (RAM), and may also include a non-volatile memory, such as at least one disk memory.

The program 910 may be specifically used to cause the processor 902 to perform operations corresponding to the method described in any of the multiple method embodiments described above.

For the specific implementation of each step in program 910, reference may be made to the corresponding descriptions in the corresponding steps and units in the above-mentioned method embodiments, and such implementation has corresponding beneficial effects, and details will not be repeated here. Those of skill in the art can clearly understand that for the convenience and simplicity of description, for the specific working process of the above-mentioned devices and modules, reference may be made to the corresponding process description in the above-mentioned method embodiments, and details will not be repeated here.

Embodiments of the present application further provides a server, including a memory, a processor, and a computer program stored on the memory, and when the processor executes the computer program, the method applied to the server as described in any of above implementations is implemented.

Embodiments of the present application further provides a computer storage medium, on which a computer program is stored, and when the program is executed by a processor, the method as described in any of above implementations is implemented.

Embodiments of the present application further provides a computer program product, including computer instructions which instruct a computing device to perform operations corresponding to any of the methods in the multiple method embodiments described above.

It should be noted that, according to the needs of implementation, the various components/steps described in the embodiments of the present application may be split into more components/steps, and two or more components/steps or partial operations of the components/steps may be combined into new components/steps to achieve the purpose of the embodiments of the present application.

The above methods according to the embodiments of the present application may be implemented in hardware, firmware, or implemented as software or computer codes that can be stored in a recording medium (such as a compact disc read-only memory (CD ROM), a RAM, a floppy disk, a hard disk or a magneto-optical disk), or implemented as computer codes originally stored in a remote recording medium or a non-transitory machine-readable medium and downloaded through a network and to be stored in a local recording medium, so that the methods described herein may be processed by such software stored on a recording medium using a general-purpose computer, a dedicated processor or programmable or dedicated hardware (such as an ASIC or field-programmable gate array (FPGA)). It can be understood that a computer, a processor, a microprocessor controller or programmable hardware includes a storage component (e.g., RAM, ROM, flash memory, etc.) that can store or receive software or computer codes, and when the software or computer codes are accessed and executed by a computer, a processor or hardware, the methods described herein are implemented. In addition, when a general-purpose computer accesses the codes for implementing the methods shown herein, the execution of the codes converts the general-purpose computer into a special-purpose computer for executing the methods shown herein.

A person of ordinary skill in the art may realize that the units and method steps of each example described in conjunction with the embodiments disclosed herein may be implemented in electronic hardware, or in combination of computer software and electronic hardware. Whether these functions are implemented in hardware or software depends on the specific application and design constraints of the technical solution. Professional technicians may use different methods to implement the described functions for each specific application, but such implementation should not be considered to exceed the scope of the embodiments of the present application.

The above implementations are only used to illustrate the embodiments of the present application, and are not intended to limit the embodiments of the present application. A person of ordinary skill in the relevant art may make various changes and modifications without departing from the spirit and scope of the embodiments of the present application. Therefore, all equivalent technical solutions also belong to the scope of the embodiments of the present application, and the patent protection scope of the embodiments of the present application shall be defined by the claims.

1. A notification processing method, comprising:
obtaining, through a cloud desktop, a notification message of a second operating system independent of an operating system of the cloud desktop;
displaying the notification message of the second operating system in a first notification area of the cloud desktop; and
receiving a trigger operation for the notification message in the first notification area, redirecting the trigger operation to the second operating system, so as to process the notification message in the second operating system according to the trigger operation.

2. The method according to claim 1, wherein the obtaining, through the cloud desktop, the notification message of the second operating system independent of the operating system of the cloud desktop comprises:
calling a notification interface of the second operating system to obtain a notification generation instruction which is used to instruct to generate a notification message; and
transmitting the notification generation instruction to the operating system of the cloud desktop, so as to generate the notification message according to the notification generation instruction through the operating system of the cloud desktop.

3. The method according to claim 2, wherein generating the notification message according to the notification generation instruction through the operating system of the cloud desktop comprises:
filtering the notification generation instruction based on a notification filtering rule of the operating system of the cloud desktop; and
generating the notification message according to the filtered notification generation instruction based on a notification display rule of the operating system of the cloud desktop.

4. The method according to claim 1, wherein the obtaining, through the cloud desktop, the notification message of the second operating system independent of the operating system of the cloud desktop comprises:
calling a notification display interface of the second operating system to obtain notification display information corresponding to the notification message;
the displaying the notification message of the second operating system in the first notification area of the cloud desktop comprises:
displaying the notification message in the first notification area of the cloud desktop according to the notification display information.

5. The method according to claim 1, wherein processing the notification message in the second operating system according to the trigger operation comprises:
in response to the trigger operation, waking up an application corresponding to the notification message to a foreground of the second operating system for display.

6. The method according to claim 1, wherein the second operating system comprises at least one of: an operating system of a terminal device for displaying the cloud desktop, an operating system of another cloud desktop independent of the cloud desktop, or an operating system of a cloud application independent of the cloud desktop.

7. A notification processing method, comprising:
obtaining a notification message of a cloud desktop through a second operating system, wherein the cloud desktop is set in a background of the second operating system;
displaying the notification message of the cloud desktop in a second notification area of the second operating system; and
receiving a trigger operation for the notification message in the second notification area, redirecting the trigger operation to the cloud desktop, so as to process the notification message in the cloud desktop according to the trigger operation.

8. The method according to claim 7, wherein processing the notification message in the cloud desktop according to the trigger operation comprises:
in response to the trigger operation, waking up the cloud desktop to a foreground of the second operating system for display, and displaying a cloud application corresponding to the triggered notification message in the cloud desktop.

9. A notification processing method, applied to a server of a cloud desktop, comprising:
receiving a notification message transmitted based on a cloud desktop protocol, wherein the notification message is a notification message of a second operating system independent of an operating system of the cloud desktop;
sending a desktop data stream to a terminal device, wherein the desktop data stream is used to display the cloud desktop, and the notification message of the second operating system is displayed in a first notification area of the displayed cloud desktop, wherein the desktop data stream is generated by the server based on a notification message of the cloud desktop and a notification message of the terminal device; and
obtaining a trigger operation transmitted by the terminal device based on the cloud desktop protocol, redirecting the trigger operation to the second operating system, and transmitting the redirected trigger operation to the second operating system, so as to process the notification message in the second operating system according to the trigger operation, wherein the trigger operation is a trigger operation for the notification message in the first notification area.

10. (canceled)

11. A terminal device, comprising: a processor, a memory, a communication interface and a communication bus, wherein the processor, the memory and the communication interface communicate with each other through the communication bus;
the memory is configured to store at least one executable instruction, wherein the executable instruction causes the processor to perform an operation corresponding to the method according to claim 1.

12. A server, comprising a memory, a processor and a computer program stored on the memory, wherein when the processor executes the computer program, the method according to claim 9 is implemented.

13. A non-transitory computer storage medium having a computer program stored thereon, wherein when the computer program is executed by a processor, the method according to claim 1 is implemented.

14. The terminal device according to claim 11, wherein the executable instruction causes the processor to:
call a notification interface of the second operating system to obtain a notification generation instruction which is used to instruct to generate a notification message; and
transmit the notification generation instruction to the operating system of the cloud desktop, so as to generate the notification message according to the notification generation instruction through the operating system of the cloud desktop.

15. The terminal device according to claim 14, wherein the executable instruction causes the processor to:
filter the notification generation instruction based on a notification filtering rule of the operating system of the cloud desktop; and
generate the notification message according to the filtered notification generation instruction based on a notification display rule of the operating system of the cloud desktop.

16. The terminal device according to claim 11, wherein the executable instruction causes the processor to:
call a notification display interface of the second operating system to obtain notification display information corresponding to the notification message; and
display the notification message in the first notification area of the cloud desktop according to the notification display information.

17. The terminal device according to claim 11, wherein the executable instruction causes the processor to:
in response to the trigger operation, wake up an application corresponding to the notification message to a foreground of the second operating system for display.

18. The terminal device according to claim 11, wherein the second operating system comprises at least one of: an operating system of a terminal device for displaying the cloud desktop, an operating system of another cloud desktop independent of the cloud desktop, or an operating system of a cloud application independent of the cloud desktop.

19. A terminal device, comprising: a processor, a memory, a communication interface and a communication bus, wherein the processor, the memory and the communication interface communicate with each other through the communication bus;
the memory is configured to store at least one executable instruction, wherein the executable instruction causes the processor to perform an operation corresponding to the method according to claim 7.

20. The terminal device according to claim 19, wherein the executable instruction causes the processor to:
in response to the trigger operation, wake up the cloud desktop to a foreground of the second operating system for display, and display a cloud application corresponding to the triggered notification message in the cloud desktop.

21. A non-transitory computer storage medium having a computer program stored thereon, wherein when the computer program is executed by a processor, the method according to claim 7 is implemented.
